(19) United States
(12) Patent Application Publication
(10) Pub. No.: US 2006/0072698 A1
(43) Pub. Date: Apr. 6, 2006

(54) Method for producing actinium-225

(76) Inventors: Alfred Morgenstern, Karlsruhe (DE); Christos Apostolidis, Heidelberg (DE); Roger Molinet, Linkenheim (DE); Klaus Lutzenkirchen, Hochstetten (DE)

Correspondence Address: CANTOR COLBURN, LLP, 55 GRIFFIN ROAD SOUTH, BLOOMFIELD, CT, 06002, US

(21) Appl. No.: 11/166,536

(22) Filed: Jun. 24, 2005

(30) Foreign Application Priority Data
Jun. 25, 2004 (EP) EP 04 102 977.8

(51) Int. Cl. G21G 1/10

(52) U.S. Cl. 376/194

(57) ABSTRACT

A method for producing Ac-225 is presented, wherein Ac-225 is produced by bombardment of Th-232 with hydrogen isotope nuclei accelerated in a cyclotron. The method, which allows production of Ac-225 at high yields and purity levels, is particularly interesting for the supply or Ac-225 or of the daughter Bi-213 for medical applications.

### FIELD OF THE INVENTION

The present invention generally relates to a method for producing actinium-225.

### BACKGROUND OF THE INVENTION

Production of actinium-225 (Ac-225) and its daughter bismuth-213 (Bi-213) is of great interest for cancer therapy, as they constitute preferred radionuclides for alpha-immunotherapy purposes. Indeed, to selectively irradiate cancer cells, alpha-immunotherapy uses alpha-emitters such as Bi-213 and/or Ac-225 that are linked, e.g. through a bifunctional chelator, to monoclonal antibodies or peptides.

EP-A-0 962 942 discloses a method for producing Ac-225, which consists of irradiating a target containing Ra-226 with protons in a cyclotron, so that metastable radionuclei are transformed into Actinium by emitting neutrons.

In order to increase the yield of Ac-225, EP-A-0 962 942 proposes to irradiate a target of Ra-226 with protons having an incident energy of between 10 and 20 MeV, preferably of about 15 MeV.

Although the above methods have proved to be effective for the production of Ac-225, they require relatively important safety measures due to the high radio-toxicity of the radium target material. The high radiation dose originating from the target material Ra-226 and its daughter nuclides causes significant problems in the technical realisation, preparation and handling of Ra-226 targets. Additionally the need to contain the gaseous, highly radioactive daughter nuclide Rn-222 (half-life: 3.8 days) within the target capsule poses high requirements to the target stability.

### OBJECT OF THE INVENTION

The object of the present invention is to provide an alternative and safer route for the production of Ac-225. This object is achieved by a method as claimed in claim 1.

### SUMMARY OF THE INVENTION

According to the present invention, actinium-225 is produced by irradiating a target of thorium-232 (Th-232) with hydrogen isotope nuclei. According to the reactions Th-232(p,4n)Pa-229 or Th-232(d,5n)Pa-229 respectively, protactinium-229 (Pa-229) is obtained, which decays via emission of an alpha-particle with a branching ratio of 0.48% into Ac-225.

In the method of the invention, Ac-225 can be produced from natural, low-radioactive thorium-232. This provides important advantages over known production methods which are based on the irradiation of Ra-226 by hydrogen nuclei. Indeed, the use of low-radioactive thorium simplifies the preparation, handling and transport of targets. It also greatly reduces safety risks associated with the irradiation of low-radioactive thorium as compared to the irradiation of highly radioactive Ra-226.

Another advantage of the present method is its relatively high production yield. Indeed, by means of a single irradiation of a thick Th-232 target for 100 hours using a proton or deuteron current of 100 μA the production of several 10 mCi of Ac-225 can be expected.

Furthermore, the present method also allows production of Ac-225 at high purity levels, which is important for therapeutic use. The present method is thus particularly well adapted for producing Ac-225 for direct use or in view of Bi-213 generation.

When implementing the present method with protons, the proton energy is preferably adjusted such that the energy incident on the Th-232 target is between 24 and 40 MeV. When using deuterons, the deuteron energy is preferably adjusted such that the energy incident on the Th-232 target is between 25 and 50 MeV. These preferred energy ranges provide Ac-225 production at relatively high yields and purity.

In practice, the present method is preferably carried out in a cyclotron, which generally permits to accelerate protons or deuterons to the preferred energy ranges.

The target material preferably is thorium metal, as Th-232 is naturally available. However, thorium targets prepared by electrodeposition or made from thorium oxide or other suitable thorium materials can be used. In other words, the target material may comprise Th-232 and other appropriate materials, depending on the target preparation technique.

During irradiation, the Th-232 target material is preferably placed in a capsule and/or any other suitable sealed container. Also, during irradiation, the capsule, respectively the sealed container, is advantageously cooled by a closed water circuit.

The use of an aluminium capsule is interesting due to the advantageous heat conductivity of aluminium that allows to perform irradiations using high particle currents while providing sufficient target cooling. Its low activation cross-sections constitutes a main advantage of aluminium, thus reducing the activation of the capsule material. Alternatively, the capsule or container, in which the target material is placed, may be made of silver so as to prevent introduction of impurities into the medical grade product, in particular during post-irradiation treatments. Silver also has a high heat conductivity and thus allows for sufficient cooling when irradiations are performed at high current densities. Additionally silver is advantageous in that, contrary to aluminium, it will not dissolve during hydrochloric acid treatment of the irradiated target.

After irradiation, actinium is preferably chemically separated from the irradiated target material. A variety of chemical separation techniques are known in the art and can be used. Preferred chemical separation techniques are ion exchange or extraction chromatography. Methods for the separation of actinium from thorium are widely described in the literature.

The present method is particularly interesting for the production of actinium-225 for use in radiotherapy. Indeed, the produced actinium-225 or daughter radionuclides thereof, in particular Bi-213, are widely employed in targeted alpha therapy (including conventional targeting or pre-targeting). The present invention thus also concerns the use of the present method to provide Ac-225 or daughter radionuclides thereof for the manufacture of radiopharmaceuticals for cancer therapy, in particular alpha-radioimmunotherapy. Typically, such radiopharmaceuticals will comprise radioconjugates consisting of the desired radionuclide bound, generally through a bifunctional chelator, to a targeting moiety such as an antibody (in particular a monoclonal antibody), a peptide, or other moiety allowing the targeting of specific cancer cells.

### BRIEF DESCRIPTION OF THE DRAWINGS

The present invention will now be described, by way of example, with reference to the accompanying drawing, in which:

FIG. 1: is a graph illustrating the cross-section of reactions Th-232(p,4n)Pa-229 and Th-232(d,5n)Pa-229 in function of the particle energy.

### DETAILED DESCRIPTION OF A PREFERRED EMBODIMENT

According to the present method Ac-225 is produced by bombardment of Th-232 with hydrogen isotope nuclei. The irradiation of the Th-232 with protons or deuterons of appropriate energy leads to the formation of Pa-229 according to the reactions Th-232(p,4n)Pa-229 or Th-232(d,5n)Pa-229, respectively. The obtained Pa-229 (half-life: 1.5 days) decays via emission of an alpha particle with a branching ratio of 0.48% into Ac-225. Taking into account the half-lives of Pa-229 and Ac-225 (half-life: 10 days), the maximum activity of Ac-225 can be separated from the irradiated target approx. 5 days after the end of irradiation. This time period at the same time allows for sufficient cooling of the target.

As already mentioned, the use of Th-232 as target material renders the present method more advantageous over production routes using Ra-226 targets in terms of preparation, handling and transport of the targets, and results in greatly reduced safety risks associated with the irradiation procedures of the targets.

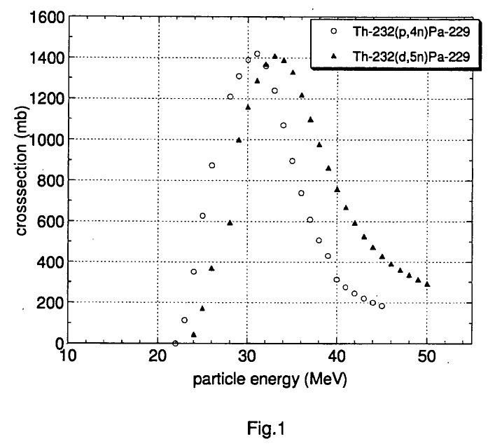

When implementing the method with protons, their energy is preferably adjusted such that the energy incident on the Th-232 target is between 24 and 40 MeV (FIG. 1). When implementing the method with deuterons, their energy is preferably adjusted such that the energy incident on the Th-232 target is between 25 and 50 MeV (FIG. 1).

Taking into account the theoretical cross-sections of the reactions Th-232(p,4n)Pa-229 and Th-232(d,5n)Pa-229 as shown in FIG. 1, the production of approx. 5 μCi of Ac-225 per μAh can be expected for the irradiation of thick Th-232 targets by protons or deuterons of the appropriate energy. As an example, by irradiation of a thick Th-232 target for 100 hours using a proton or deuteron current of 100 μA the production of several 10 mCi of Ac-225 can be expected.

The proposed method will yield an actinium-225 product of high isotopic purity formed through the decay of Pa-229. In the energy ranges indicated above, only low amounts of Pa-228 and Pa-230 will be produced as side products. Furthermore, through the decay of Pa-228 and Pa-230, respectively, only negligible amounts of the relatively short-lived actinium isotopes Ac-224 (T_{1/2}=2.4 hours) and Ac-226 (T_{1/2}=29 hours) are formed. Regarding more precisely the target material for irradiation, it preferably consists of thorium metal for example in the form of a disk, plate or other solid piece. The main advantages of using thorium metal as target material are the ease of its preparation and handling, its mechanical stability, and the fact that it is insoluble in water, thus limiting the risk of contamination of the cooling circuit. However, other forms of thorium material may be used, e.g. thorium oxide or targets prepared by electrodeposition.

In order to increase production yields, the cyclotron irradiation can be advantageously performed on an internal target of Th-232 placed in the main chamber of a cyclotron, where beam intensities of several mA can be reached. This can be realised in a relatively straightforward manner for solid targets of thorium metal.

During irradiation, the Th-232 target material is preferably placed in a capsule and/or any other suitable sealed container, e.g. made of silver or aluminium and cooled by a closed water circuit. After irradiation, actinium is separated from the irradiated target material, preferably by chemical separation using e.g. conventional techniques. Chemical separation can be performed using ion exchange or extraction chromatography, e.g. in a manner analogous to the well established Th-229/Ac-225 separation. Methods for the separation of actinium from thorium are widely described in the literature.

As already mentioned, Ac-225 and its daughter nuclides are of great interest for cancer therapy. A typical application is the linking (via e.g. a bifunctional chelator) of Ac-225 or of the daughter Bi-213 to a targeting moiety such as e.g. a monoclonal antibody or a peptide, to deliver the cytotoxic radionuclide to specific cancer cells. The preparation of Bi-213 from Ac-225 is well known in the art and is typically carried out by elution from a separation column (filled with ion exchange resin or extraction chromatographic material) loaded with Ac-225.

1. A method for producing Actinium-225, comprising the steps of:
preparing a target of thorium-232; and
irradiating said target of thorium-232 with hydrogen isotope nuclei.

2. The method according to claim 1, wherein said hydrogen isotope nuclei are protons.

3. The method according to claim 2, wherein said protons have an incident energy between 24 and 40 MeV.

4. The method according to claim 1, wherein said hydrogen isotope nuclei are deuterons.

5. The method according to claim 4, wherein said deuterons have an incident energy of between 25 and 50 MeV.

6. The method according to claim 1, wherein said hydrogen isotope nuclei are accelerated in a cyclotron.

7. The method according to claim 1, wherein said target of Th-232 is in the form of a solid piece of thorium metal.

8. The method according to claim 1, wherein said target of Th-232 comprises Th-232 and other appropriate material, depending on the target preparation step.

9. The method according to claim 1, wherein during irradiation, said target is received in a sealed capsule or container, which is cooled by a closed cooling circuit.

10. The method according to claim 1, further comprising, after said irradiation step, the step of chemically separating actinium from the irradiated target material.

11. The method according to claim 10, wherein said separation step is carried out approximately 5 days following irradiation.

12. Use of the method according to claim 1 in a method of preparing a radio-pharmaceutical comprising Ac-225 and/or one of its daughter radionuclides.
